(19) United States
(12) Patent Application Publication
(10) Pub. No.: US 2023/0003311 A1
(43) Pub. Date: Jan. 5, 2023

(54) ELECTROMAGNETIC VALVE MODULE

(71) Applicant: NIDEC TOSOK CORPORATION, Kanagawa (JP)

(72) Inventors: Saori NUIYA, Kanagawa (JP); Sho TANABE, Kanagawa (JP)

(21) Appl. No.: 17/844,666

(22) Filed: Jun. 20, 2022

(30) Foreign Application Priority Data
Jun. 30, 2021 (JP) 2021-108647

(51) Int. Cl. F16K 31/06; F16K 27/00; F16K 27/12

(52) U.S. Cl. CPC F16K 31/0675; F16K 27/003; F16K 27/12

(57) ABSTRACT

Improvement of maintainability in a device on which a solenoid valve is mounted. An aspect of an electromagnetic valve module includes a cover detachably attached to an attachment portion of a housing as a part of the housing enclosing a fluid control device that controls fluid by a detachably attached electromagnetic valve, and an electromagnetic valve attached to the cover and mounted on the fluid control device as the cover is attached to the attachment portion.

### CROSS-REFERENCE TO RELATED APPLICATIONS

The present invention claims priority under 35 U.S.C. § 119 to Japanese Patent Application No. 2021-108647 filed on Jun. 30, 2021, the entire content of which is incorporated herein by reference.

### FIELD OF THE INVENTION

The present invention relates to an electromagnetic valve module.

### BACKGROUND

Conventionally, an electromagnetic valve represented by a solenoid valve is used for control of line pressure for gear shift control and clutch pressure at the time of gear shift in, for example, an automatic transmission.

For example, conventionally, in an attachment structure of a solenoid valve in which the solenoid valve is inserted into and attached to a fitting hole of a valve body, a technique capable of preventing erroneous assembly of the solenoid valve has been proposed.

However, in a general attachment structure of a solenoid valve, in a case where a failure occurs in a solenoid valve, it is difficult to replace only the solenoid valve in which the failure occurs, and it is necessary to remove an entire valve body from an automatic transmission, which leads to poor maintainability and workability.

### SUMMARY

An aspect of an exemplary electromagnetic valve module according to the present invention includes a cover detachably attached to an attachment portion of a housing as a part of the housing enclosing a fluid control device that controls fluid by a detachably attached electromagnetic valve, and an electromagnetic valve attached to the cover and mounted on the fluid control device as the cover is attached to the attachment portion.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a schematic structural diagram illustrating an automatic transmission (transmission) in which an embodiment of an electromagnetic valve module of the present invention is incorporated;

FIG. 2 is a diagram illustrating a state in which the electromagnetic valve module and a fluid control device are combined;

FIG. 3 is a diagram illustrating a state in which the electromagnetic valve module and the fluid control device are separated from each other;

FIG. 4 is a diagram illustrating a mounting portion of the fluid control device;

FIG. 5 is a perspective view illustrating a structure of an electromagnetic valve; and

FIG. 6 is a cross-sectional view illustrating a structure of the electromagnetic valve.

### DETAILED DESCRIPTION

Hereinafter, an embodiment of an electromagnetic valve module of the present disclosure will be described in detail with reference to the accompanying drawings. However, in order to avoid description below from being unnecessarily redundant and to make it easier for those skilled in the art to understand, detailed description more than necessary may be omitted. For example, detailed description of well-known matters and duplicate description of substantially the same configuration may be omitted. Elements described in a diagram described earlier may be appropriately referred to in description of a later diagram.

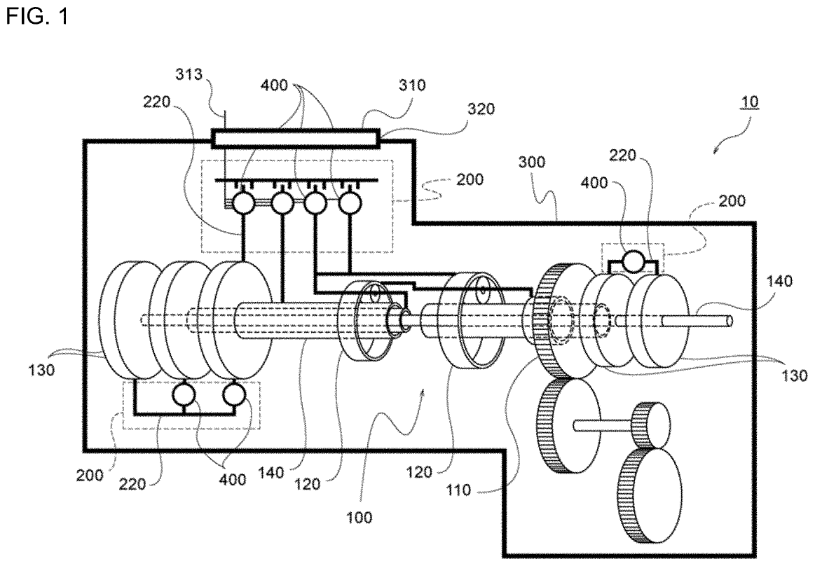

FIG. 1 is a schematic structural diagram illustrating an automatic transmission (transmission) in which an embodiment of the electromagnetic valve module of the present invention is incorporated.

A transmission 10 includes a gear assembly 100 and a hydraulic control device 200 in a housing 300.

The gear assembly 100 has a structure in which a drive gear 110 and a planetary gear 120 are connected via a clutch 130 and a shaft 140.

The hydraulic control device 200 has an oil passage 220 through which fluid (for example, oil) flows, and an electromagnetic valve 400 opens and closes the oil passage 220. More specifically, the hydraulic control device 200 includes a plurality of the oil passages 220 leading to each portion of the gear assembly 100, and changes flow of oil by opening and closing the oil passage 220 by the electromagnetic valve 400 to change a connection structure of a gear in the gear assembly 100 to switch a reduction ratio and the like.

The hydraulic control device 200 corresponds to an example of the fluid control device according to the present invention that controls fluid by the electromagnetic valve 400 that is detachably mounted, and the hydraulic control device 200 in the present embodiment controls the transmission 10 by fluid control. The electromagnetic valve 400 corresponds to an example of the electromagnetic valve according to the present invention, and the electromagnetic valve 400 according to the present embodiment controls flow of oil as an example of fluid. The electromagnetic valve 400 operates by being supplied with electric power from the outside of the housing 300 by a wiring cord 313.

Note that, in FIG. 1, the hydraulic control device 200 is illustrated at a plurality of locations to illustrate a function of the hydraulic control device 200, but one of the hydraulic control devices 200 is actually provided inside a detachable cover 310 of the housing 300.

The detachable cover 310 is detachably attached to an attachment portion 320 of the housing 300 as a part of the housing 300 that encloses the fluid control device 200 and the gear assembly 100.

As will be described later, the electromagnetic valve 400 is attached to the detachable cover 310, and is mounted on the fluid control device 200 as the detachable cover 310 is attached to the attachment portion 320.

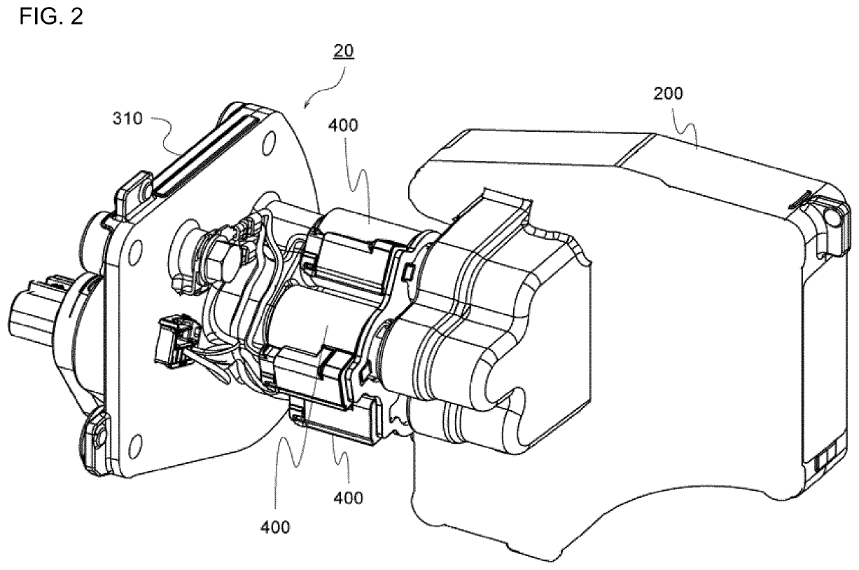

A combination of the detachable cover 310 and the electromagnetic valve 400 corresponds to an embodiment of an electromagnetic valve module 20 (FIG. 2) of the present invention, and the detachable cover 310 corresponds to an example of the cover according to the present invention.

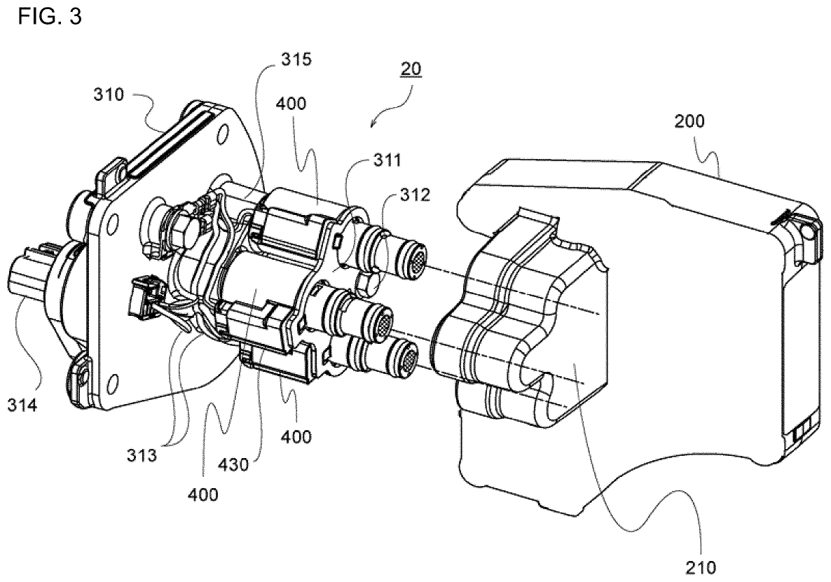

FIGS. 2 and 3 are diagrams illustrating the electromagnetic valve module 20 and the fluid control device 200. FIG. 2 illustrates a state in which the electromagnetic valve module 20 and the fluid control device 200 are combined, and FIG. 3 illustrates a state in which the electromagnetic valve module 20 and the fluid control device 200 are separated. An alternate long and short dash line in FIG. 3 indicates a separation/mounting direction of the electromagnetic valve module 20 with respect to the fluid control device 200. Since the detachable cover 310 is apart of the electromagnetic valve module 20, the alternate long and short dash line in FIG. 3 also indicates the separation/mounting direction of the detachable cover 310 with respect to the attachment portion 320.

In description below, the electromagnetic valve module 20 including three of the electromagnetic valves 400 is illustrated as an example. The electromagnetic valve 400 is fixed to the detachable cover 310, and the electromagnetic valve 400 is attached to and detached from the fluid control device 200 as the detachable cover 310 is attached to and detached from the attachment portion 320 of the housing 300.

The fluid control device 200 includes amounting portion 210 on which the electromagnetic valve 400 is mounted. The mounting portion 210 is positioned in front of the electromagnetic valve 400 of the electromagnetic valve module 20 in the mounting direction (the mounting direction of the detachable cover 310 on the attachment portion 320).

As the electromagnetic valve module 20 is employed, the electromagnetic valve 400 is attached to and detached from the fluid control device 200 along with attachment and detachment of the detachable cover 310, so that maintainability of the electromagnetic valve 400 is improved as compared with a structure in which the electromagnetic valve 400 is fixed to the fluid control device 200 side.

In the present embodiment, since the electromagnetic valve module 20 is applied to the housing 300 of the transmission 10 corresponding to an example of the housing according to the present invention, maintainability of the transmission 10 is improved.

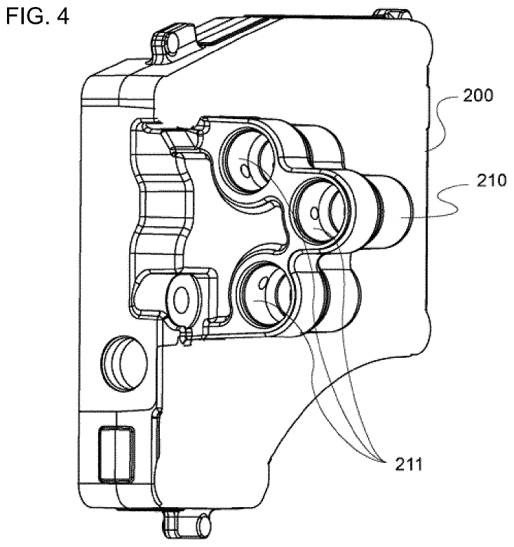

FIG. 4 is a view illustrating the mounting portion 210 of the fluid control device 200.

The mounting portion 210 of the fluid control device 200 is provided with three insertion holes 211 into which tip portions of three of the electromagnetic valves 400 are inserted. The oil passage 220 described above is connected to each of the insertion holes 211, and each of the electromagnetic valves 400 opens and closes each of the oil passages 220.

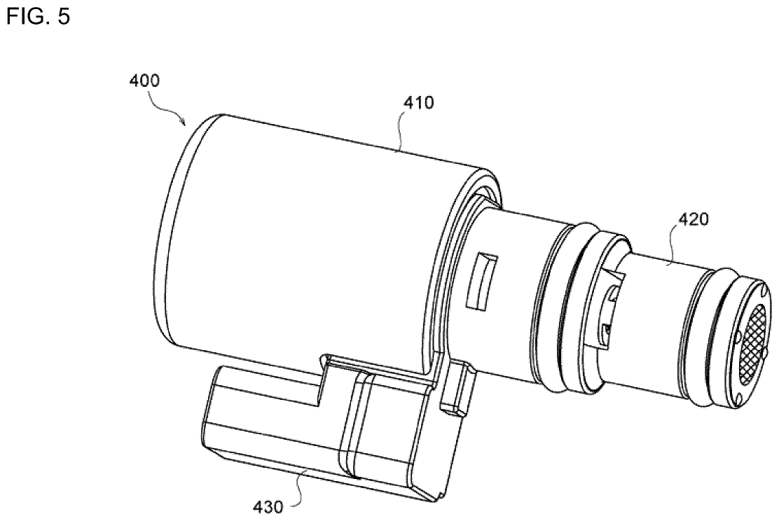

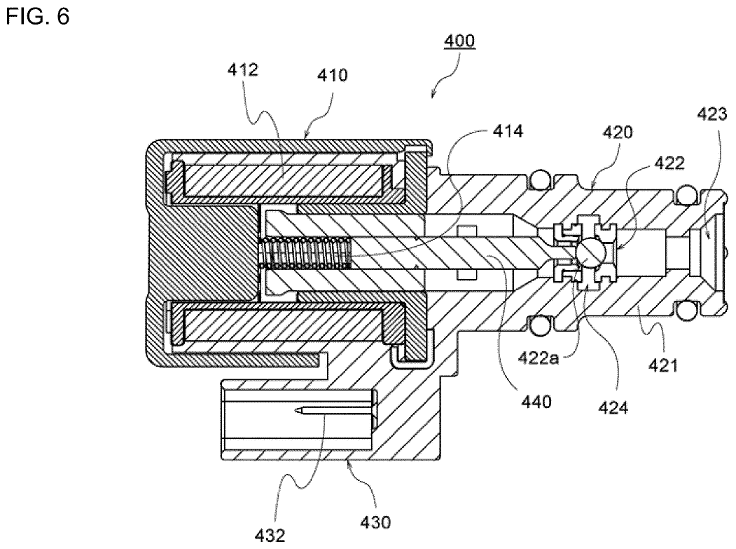

FIGS. 5 and 6 are diagrams illustrating a structure of the electromagnetic valve 400. FIG. 5 is a perspective view of the electromagnetic valve 400, and FIG. 6 is a cross-sectional view of the electromagnetic valve 400.

The electromagnetic valve 400 has a main body unit 410, an output unit 420, and a connector unit 430 in appearance, and has a solenoid coil 412, a push spring 414, a plunger 440, a valve portion 422, an inflow path 423, an outflow path 424, and the like in the inside.

The main body unit 410 receives supply of electric power and drives the plunger 440.

The output unit 420 is inserted into the above-described hydraulic control device 200 and opens and closes the above-described oil passage 220 by movement of the plunger 440.

The wiring cord 313 (see FIG. 3) that supplies power to the main body unit 410 is connected to the connector unit 430.

The plunger 440 has a first end side extending into the output unit 420 and a second end side inserted into the main body unit 410, and moves in an axial direction of the plunger 440 (direction defined by the first end side and the second end side of the plunger 440). In description below, with the plunger 440 as a reference in the axial direction, the right side in FIG. 6 may be referred to as “the first end side in the axial direction”, and the left side in FIG. 6 may be referred to as “the second end side in the axial direction”.

The main body unit 410 includes the solenoid coil 412 and the push spring 414, and the plunger 440 is attracted toward the second end side in the axial direction by a magnetic field generated by the solenoid coil 412. The push spring 414 pushes back the plunger 440 to the first end side in the axial direction when the magnetic field of the solenoid coil 412 is cut off.

The output unit 420 includes a cylindrical portion 421 and a valve portion 422.

The cylindrical portion 421 is made from resin and has a cylindrical structure extending toward the first end side in the axial direction with respect to the main body unit 410. The cylindrical portion 421 has the inflow path 423 and the outflow path 424 in the inside.

The valve portion 422 is provided between the inflow path 423 and the outflow path 424 of the cylindrical portion 421, and when a tip of the plunger 440 presses the sphere 422a in the valve portion 422, the valve portion 422 is closed to block between the inflow path 423 and the outflow path 424. When the tip of the plunger 440 is separated from the sphere 422a in the valve portion 422, the valve portion 422 is opened, the inflow path 423 and the outflow path 424 are connected, and oil flows.

The connector unit 430 has a terminal 432 connected to a first end of a winding of the solenoid coil 412, and power can be easily supplied to the solenoid coil 412 via the connector unit 430.

The description will be continued returning to FIG. 3.

The electromagnetic valve 400 is held by a holding plate 311, and the holding plate 311 is fixed to the detachable cover 310 with a bolt 312. The detachable cover 310 has a fixing portion 315 protruding in a table shape toward the inside of the housing 300, and the electromagnetic valve 400 is fixed to the fixing portion 315 of the detachable cover 310 by fixing of the holding plate 311 with the bolt 312.

The electromagnetic valve 400 has the valve portion 422 described above on the first end side in the axial direction mounted on the fluid control device 200, and as illustrated in FIG. 3, a portion closer to the second end side in the axial direction of the electromagnetic valve 400 than the valve portion 422 is fixed to the fixing portion 315 of the detachable cover 310. The detachable cover 310 is attached to the attachment portion 320 by approaching the first end side in the axial direction from the second end side in the axial direction. As a result, the valve portion 422 of the electromagnetic valve 400 is easily inserted into the insertion hole 211 of the mounting portion 210 along with linear movement of mounting of the detachable cover 310 on the attachment portion 320.

The electromagnetic valve 400 is driven by power supplied from the detachable cover 310 side by the wiring cord 313. The wiring cord 313 penetrates the inside and outside of the housing 300 via the connector 314, and power is supplied from a power supply (not illustrated) outside the transmission 10. That is, the detachable cover 310 has the wiring cord 313 penetrating the inside and outside of the housing 300, and the electromagnetic valve 400 is electrically connected to the wiring cord 313 and obtains driving power via the wiring cord 313. In this manner, power is supplied to the electromagnetic valve 400 with a simple wiring structure. The wiring cord 313 corresponds to an example of the wiring according to the present invention. Further, since the wiring cord 313 is provided on the detachable cover 310, the wiring cord 313 is also attached to and detached from the housing 300 together with the detachable cover 310, so that maintainability is further improved.

Here, a transmission is exemplified as a method of use in the electromagnetic valve module of the present invention, but the method of use of the electromagnetic valve module of the present invention is not limited to the above, and the electromagnetic valve module of the present invention can be used in a wide range such as a robot that operates by hydraulic pressure, a fluid control device that controls water, air, and the like.

It is to be considered that the embodiment described above is illustrative in all aspects, and is not restrictive. The scope of the present invention is illustrated not by the above-described embodiment but by the scope of the claims, and is intended to include all changes within the meaning and scope equivalent to the scope of claims.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. An electromagnetic valve module comprising:
a cover detachably attached to an attachment portion of a housing as a part of the housing enclosing a fluid control device that controls fluid by a detachably attached electromagnetic valve; and
an electromagnetic valve attached to the cover and mounted on the fluid control device as the cover is attached to the attachment portion.

2. The electromagnetic valve module according to claim 1, wherein
the electromagnetic valve has a valve portion on a first end side mounted on the fluid control device, and has a portion closer to a second end side than the valve portion fixed to a fixing portion of the cover, and
the cover is attached to the attachment portion in a manner approaching the first end side from the second end side.

3. The electromagnetic valve module according to claim 1, wherein
the fluid control device includes a flow path through which fluid flows, and
the electromagnetic valve opens and closes the flow path.

4. The electromagnetic valve module according to claim 1, wherein
the cover has a wiring penetrating an inside and an outside of the housing, and
the electromagnetic valve is electrically connected to the wiring and obtains driving power via the wiring.

5. The electromagnetic valve module according to claim 1, wherein
the fluid control device controls a transmission by fluid control, and
the housing is a housing of the transmission.
